(19) United States
(12) Patent Application Publication
(10) Pub. No.: US 2017/0237665 A1
(43) Pub. Date: Aug. 17, 2017

(54) PACKET PROCESSING METHOD AND PACKET PROCESSING SYSTEM

(71) Applicant: FUJITSU LIMITED, Kawasaki-shi (JP)

(72) Inventors: Mitsuhiro Sato, Fukuoka (JP); Koichi Yamamoto, Fukuoka (JP); Yosuke Gondo, Fukuoka (JP); SHINICHI HAYASHI, FUKUOKA (JP); Wataru Kawaguchi, Fukuoka (JP)

(73) Assignee: FUJITSU LIMITED, Kawasaki-shi (JP)

(21) Appl. No.: 15/422,848

(22) Filed: Feb. 2, 2017

(30) Foreign Application Priority Data
Feb. 17, 2016 (JP) 2016-028230

(51) Int. Cl. H04L 12/803; H04L 12/26; H04L 12/935

(52) U.S. Cl. CPC H04L 47/125; H04L 49/30; H04L 43/06

(57) ABSTRACT

A packet processing method executed by a system including a first apparatus and a second apparatus, the first apparatus having a first processor and a plurality of interfaces and a second apparatus having a second processor and a plurality of third processors, the packet processing method includes receiving, by the first processor, a packet via an interface in the plurality of interfaces; storing identification information of the interface into the packet; transmitting the packet to the second apparatus; receiving, by the second processor, the packet transmitted from the first apparatus; selecting a processor from the plurality of third processors based on the identification information included in the received packet; and executing processing of the packet using the selected processor.

### CROSS-REFERENCE TO RELATED APPLICATION

This application is based upon and claims the benefit of priority of the prior Japanese Patent Application No. 2016-028230, filed on Feb. 17, 2016, the entire contents of which are incorporated herein by reference.

### FIELD

The embodiments discussed herein are related to a packet processing method and a packet processing system.

### BACKGROUND

FIG. 18 is a diagram illustrating an example of a configuration of a conventional network monitoring system. As illustrated in FIG. 18, the network monitoring system includes terminal devices 1a to 1e, base stations 2a to 2c, networks 5a to 5d, a quality monitoring system 8, and a management system 9.

The terminal devices 1a to 1e are terminal devices used by users, each of which represents a mobile phone, a smartphone, a notebook personal computer (PC). In the following description, the terminal devices 1a to 1e are collectively denoted by the terminal device 1 as needed.

The base stations 2a to 2c are facilities that relay communication between the terminal device 1 and a network. For instance, the base station 2a relays communication between the terminal devices 1a, 1b and the network 5a. The base station 2b relays communication between the terminal devices 1c, 1d and the network 5b. The base station 2c relays communication between the terminal device 1e and the network 5b.

The networks 5a, 5b are networks that have an exchange, TAPs 6a to 6c, and others. Here, illustration of the exchange is omitted. An exchange included in the network 5a relays communication between the base station 2a and the network 5d. An exchange in the network 5b relays communication between the base stations 2b, 2c and the network 5d.

The TAPs 6a to 6c are branching units. The TAPs 6a to 6c are units that perform mirroring on a packet flowing through a network, and that output the packet, which has undergone mirroring, to the quality monitoring system 8. For instance, the TAP 6a outputs a packet flowing through the network 5a to a passive probe 7a of the quality monitoring system 8. The TAPs 6b, 6c each output a packet flowing through the network 5b to a passive probe 7b of the quality monitoring system 8.

The network 5c is a network that includes a service node that manages the information of members. The network 5d is a network that represents an internet protocol (IP) router network or the like. For instance, terminal devices 1 mutually communicate via the networks 5a, 5d, 5b.

The quality monitoring system 8 has the passive probes 7a, 7b and a manager 8a. In the following description, the passive probes 7a, 7b are collectively denoted by the passive probe 7 as needed. The passive probe 7 is an apparatus that captures packets flowing through a network via a TAP, and generates statistical information. For instance, the statistical information includes information regarding a packet loss rate per unit time and response times of packets. There are instances where the passive probe 7 is operated on a dedicated machine and instances where driver software or application software is installed to a general to purpose server and the passive probe 7 is operated on the server.

For instance, the passive probe 7a obtains a packet from the TAP 6a, and generates statistical information. The passive probe 7b obtains a packet from the TAPs 6b, 6c, and generates statistical information. The passive probe 7 transmits generated statistical information to the manager 8a.

The manager 8a is an apparatus that receives statistical information from each passive probe 7, and detects deterioration of a network based on the statistical information. The manager 8a, when detecting a deterioration of a network based on the statistical information, transmits an alarm indicating the detail and occurrence location of the deterioration to an alarm management system 9a.

The management system 9 has the alarm management system 9a. The alarm management system 9a, when receiving an alarm, records information on the alarm. A maintenance person of the management system 9 checks the detail of the alarm, and takes recovery measures such as switching, resetting, and route changing of the relevant apparatuses in the network. As related art, for instance, Japanese Laid-open Patent Publication No. 9-261254 is disclosed.

However, the conventional technology described above has a problem in that load distribution of predetermined processing for each packet may not be performed simply and efficiently.

### SUMMARY

According to an aspect of the invention, a packet processing method executed by a system including a first apparatus and a second apparatus, the first apparatus having a first processor and a plurality of interfaces and the second apparatus having a second processor and a plurality of third processors, the packet processing method includes receiving, by the first processor, a packet via an interface in the plurality of interfaces; storing identification information of the interface into the packet; transmitting the packet to the second apparatus; receiving, by the second processor, the packet transmitted from the first apparatus; selecting a processor from the plurality of third processors based on the identification information included in the received packet; and executing processing of the packet using the selected processor.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating the configuration of a system according to a first embodiment;

FIG. 2 is a diagram illustrating an example network;

FIG. 3 is a functional block diagram illustrating the configuration of a physical tag assignment apparatus according to the first embodiment;

FIG. 4 is a table illustrating an example data structure of assignment information;

FIG. 5 is a diagram illustrating an example data structure of a packet before a physical tag is assigned;

FIG. 6 is a diagram illustrating an example data structure of a packet after a physical tag is assigned;

FIG. 7 is a functional block diagram illustrating the configuration of a quality monitoring apparatus according to the first embodiment;

FIG. 8 is a table illustrating an example data structure of a load configuration file according to the first embodiment;

FIG. 9 is a diagram for illustrating the processing of a packet distribution unit according to the first embodiment;

FIG. 10 is a flowchart illustrating the processing steps performed by the physical tag assignment apparatus according to the first embodiment;

FIG. 11 is a flowchart illustrating the processing steps performed by the quality monitoring apparatus according to the first embodiment;

FIG. 12 is a diagram illustrating the configuration of a system according to a second embodiment;

FIG. 13 is a functional block diagram illustrating the configuration of a quality monitoring apparatus according to the second embodiment;

FIG. 14 is a table illustrating an example data structure of a load configuration file according to the second embodiment;

FIG. 15 is a flowchart illustrating the processing steps performed by the quality monitoring apparatus according to the second embodiment;

FIG. 16 is a diagram illustrating an example hardware configuration of a computer representing the physical tag assignment apparatus;

FIG. 17 is a diagram illustrating an example hardware configuration of a computer representing the quality monitoring apparatus;

FIG. 18 is a diagram illustrating an example configuration of a conventional network monitoring system;

FIG. 19 is a functional block diagram illustrating the configuration of a passive probe in related art;

FIG. 20 is a diagram for illustrating distribution to cores in related art;

FIG. 21 is a diagram illustrating example L1, L2, L3 caches; and

FIG. 22 is a diagram illustrating an example system in related art.

### DESCRIPTION OF EMBODIMENTS

Hereinafter, an embodiment of a packet processing unit, a packet processing system, and a packet processing method disclosed by the present application will be described in detail with reference to the drawings. The present disclosure is not limited by the embodiments.

### First Embodiment

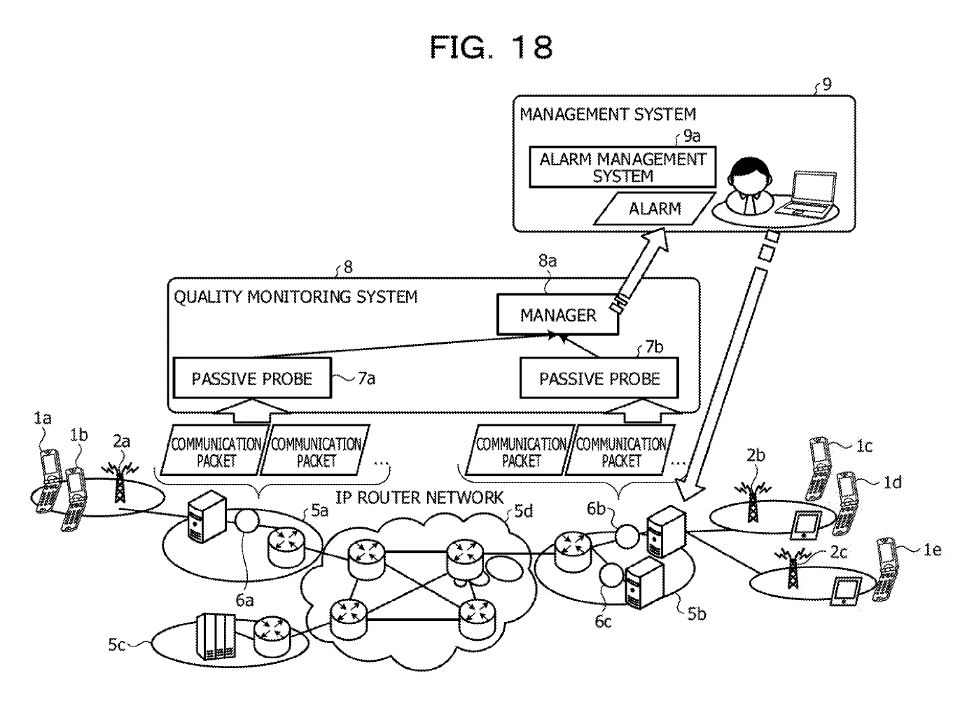

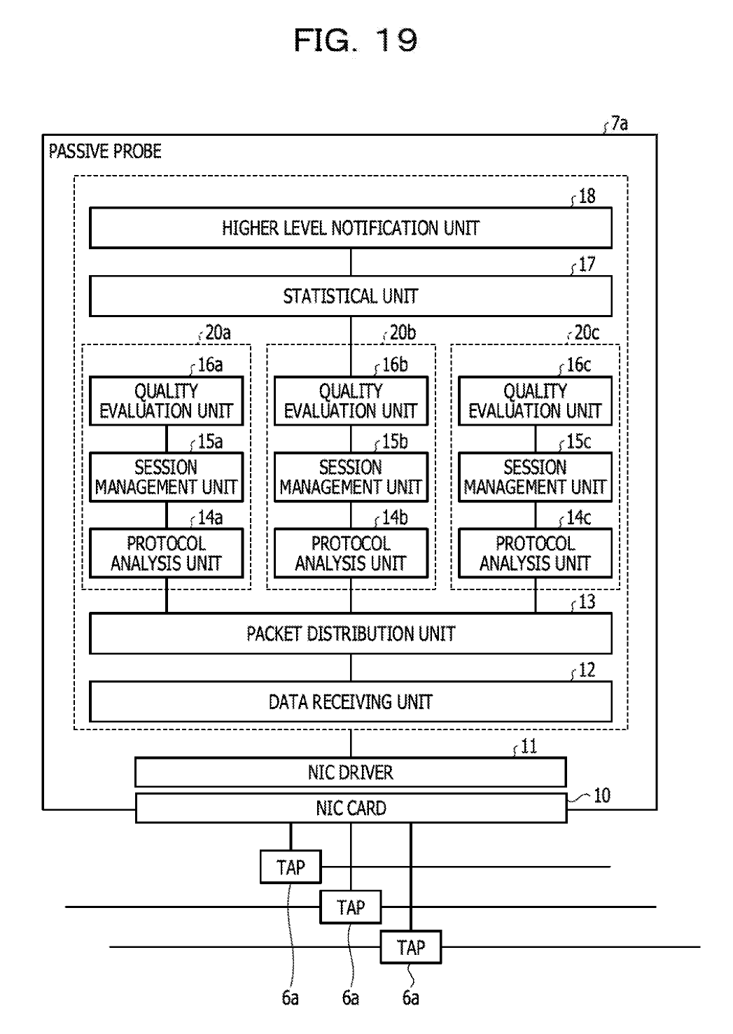

First, before the embodiment is described, an example configuration of the passive probe 7a illustrated as related art in FIG. 18 will be described. FIG. 19 is a functional block diagram illustrating the configuration of a passive probe in related art. As illustrated in FIG. 19, the passive probe 7a includes a network interface card (NIC) card 10, a NIC driver 11, a data receiving unit 12, a packet distribution unit 13, a protocol analysis units 14a to 14c, session management units 15a to 15c, quality evaluation units 16a to 16c, a statistical unit 17, and a higher level notification unit 18.

The protocol analysis unit 14a, the session management unit 15a, and the quality evaluation unit 16a are processed by a core 20a. The protocol analysis unit 14b, the session management unit 15b, and the quality evaluation unit 16b are processed by a core 20b. The protocol analysis unit 14c, the session management unit 15c, and the quality evaluation unit 16c are processed by a core 20c. The cores 20a to 20c each represent a central processing unit (CPU) or the like. The passive probe 7a may have a core other than the cores 20a to 20c.

The NIC card 10 is an apparatus that receives a packet from the TAP 6a. The NIC driver 11 is a processing unit that controls the NIC card 10. The NIC driver 11 outputs a packet received from the TAP 6a to the data receiving unit 12.

The data receiving unit 12 is a processing unit that obtains a packet from the NIC driver 11. Each time the data receiving unit 12 obtains a packet, the data receiving unit 12 outputs the packet to the packet distribution unit 13.

The packet distribution unit 13 is a processing unit that distributes a packet to the cores 20a to 20c. The specific processing of the packet distribution unit 13 will be described later.

The protocol analysis units 14a to 14c are processing units that refer to the information in the header/payload of the packet distributed by the packet distribution unit 13, and extract information which is used for determining session management and statistical information. The protocol analysis units 14a to 14c output the information extracted from a packet to the session management units 15a to 15c.

The session management units 15a to 15c are processing units that perform resource management for state management of each session and holding statistical information, based on the information extracted from a packet by the protocol analysis units 14a to 14c. The session management units 15a to 15c output the information obtained from the protocol analysis units 14a to 14c to the quality evaluation units 16a to 16c.

The quality evaluation units 16a to 16c are processing units that calculate statistical information per session managed by the session management units 15a to 15c, based on the information extracted from a packet by the protocol analysis units 14a to 14c. The quality evaluation units 16a to 16c output the statistical information to the statistical unit 17.

The statistical unit 17 is a processing unit that obtains statistical information from the quality evaluation units 16a to 16c. The statistical unit 17 summarizes the statistical information in a certain cycle, and outputs the summarized statistical information to the higher level notification unit 18. In the following description, the statistical information summarized in a certain cycle is denoted by the quality information as needed.

The higher level notification unit 18 is a processing unit that transmits quality information to an external server such as the manager 8a.

Next, a method of distributing packets performed by the packet distribution unit 13 illustrated in FIG. 19 will be described. As an example, a first distribution method, a second distribution method performed by the packet distribution unit 13 will be described.

The first distribution method will be described. The packet distribution unit 13 assigns packets to the cores 20a to 20c in a round-robin fashion in accordance with the order of arrival packets.

The second distribution method will be described. The packet distribution unit 13 determines a distribution destination by performing an operation using a specific hash function on a combination of address, port number, protocol number in an object packet to be processed. As an example of the packet distribution unit 13, when packets are distributed to two cores by a distribution method based on 5-tuple-hash algorithm, for instance, the following processing is performed. The distribution method is such that a result of hash operation is determined by using all five pieces of information: the transmission source IP address (Src IP), the destination IP address (Dst IP), the protocol number (Protocol-number), the transmission source port number (Src Port) in a TCP/UDP header, and the destination port number (Dst Port) of an object packet to be processed. Then when the number of the result is even, the packet is outputted to the first core, and when the number of the result is odd, the packet is outputted to the second core.

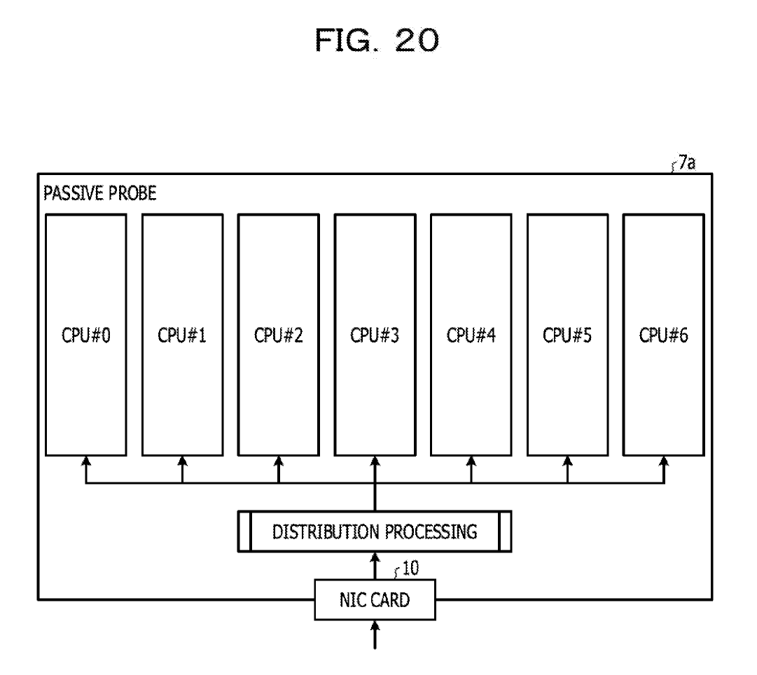

FIG. 20 is a diagram for illustrating distribution to cores in related art. For instance, the passive probe 7a performs distribution processing, and outputs a packet to one of the CPU #0 to CPU #6. For instance, the CPU #0 to CPU #2 correspond to the cores 20a to 20c of FIG. 19. The CPUs #3 to #6 correspond to cores not illustrated in FIG. 19. For instance, a driver of the NIC card 10 performs distribution processing. The distribution processing of FIG. 20 corresponds to the processing performed by the packet distribution unit 13 illustrated in FIG. 19.

For instance, the passive probe 7a calculates a hash value of a packet by the 5-tuple-hash algorithm. The passive probe 7a then outputs a packet with the same hash value to the same CPU. Since it is often the case that the above-mentioned five pieces of information of related packets are the same, the related packets may be assigned to the same CPU. Consequently, the related packets are stored in L2 cache on the same CPU, which enables high speed processing.

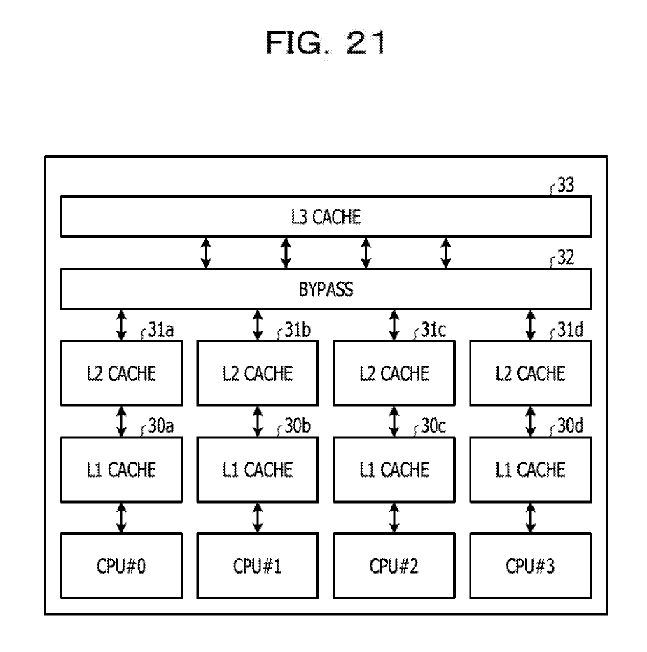

FIG. 21 is a diagram illustrating example L1, L2, L3 caches. As illustrated in FIG. 21, the CPU #0 has L1 cache 30a and L2 cache 31a, and is coupled to a bypass 32. The CPU #1 has L1 cache 30b and L2 cache 31b, and is coupled to the bypass 32. The CPU #2 has L1 cache 30c and L2 cache 31c, and is coupled to the bypass 32. The CPU #3 has L1 cache 30d and L2 cache 31d, and is coupled to the bypass 32.

For instance, when it is possible to process related packets in the L1 caches 30a to 30d, the CPUs #0 to #3 achieve the highest processing. When it is not possible to store some of the packets in the L1 caches 30a to 30d, the CPUs #0 to #3 stores the some packets in L2 caches 31a to 31d as much as possible. The CPUs #0 to #3 then perform processing on assigned packets.

On a network to be monitored, at the start of communication, a session is first established by a control signal protocol, and user data flows in the session. When the communication is completed, the session is terminated. In the following description, a packet transmitted and received at the time of session establishment is denoted by a control plane (C-Plane) packet. Also, user data is denoted by a user plane (U-Plane) packet.

For instance, in a voice service provided by a communication carrier, a C-Plane packet is transmitted and received based on a session initiation protocol (SIP), and a session is established. In the voice service, after a session is established, a U-Plane packet is transmitted and received based on a real-time transport protocol (RTP)/RTP control protocol (RTCP). In a conventional voice service, processing of establishment and termination of the session is repeatedly performed.

The statistical information described above is evaluated per session. Thus, assignment of a C-Plane packet and a U-Plane packet in the same session to the same core allows efficient generation of statistical information.

Here, the information for associating a C-Plane packet with a U-Plane packet is only obtained by an analysis up to the L7 layer and the IP addresses of a C-Plane packet and a U-Plane packet are often different even with the same session. Therefore, when a distribution destination is determined by calculation of a hash value from an IP address as in a conventional art, it is not possible to assign a C-Plane packet and a U-Plane packet in the same session to the same core. Thus, each core shares the information on a C-Plane packet and a U-Plane packet in the same session to generate statistical information, and consequently, processing by a single core is not possible and statistical information may not be efficiently generated.

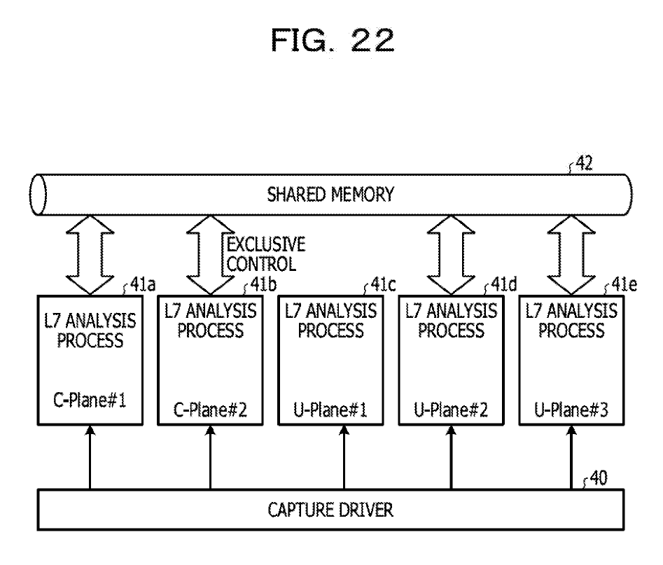

Incidentally, there is a technique for associating a C-Plane packet with a U-Plane packet by an analysis up to the L7 layer. FIG. 22 is a diagram illustrating an example system in related art. As illustrated in FIG. 22, the system includes a capture driver 40, L7 analysis processes 41a to 41e, and a shared memory 42.

The capture driver 40 outputs a C-Plane packet and a U-Plane packet to one of the L7 analysis processes 41a to 41e based on the 5-tuple-hash algorithm.

The L7 analysis processes 41a to 41e process a C-Plane packet and a U-Plane packet in the same session by separate L7 analysis processes. The L7 analysis processes 41a to 41e then store management information obtained from the L7 layer used for the association in the shared memory 42 by which all processes may be referenced. The L7 analysis processes 41a to 41e refer to the management information while performing exclusive control between the processes. The L7 analysis processes 41a to 41e then obtain the information stored in the memory on related C-Plane packet and U-Plane packet to generate statistical information.

At this point, along with an increase in the data amount of C-Plane packets and U-Plane packets flowing through a network, or the number of sessions, a waiting time due to exclusive control increases, and it is not possible to calculate statistical information efficiently.

An aspect of the present disclosure provides a packet processing unit, a packet processing system, and a packet processing method capable of performing load distribution of predetermined processing for each packet simply and efficiently.

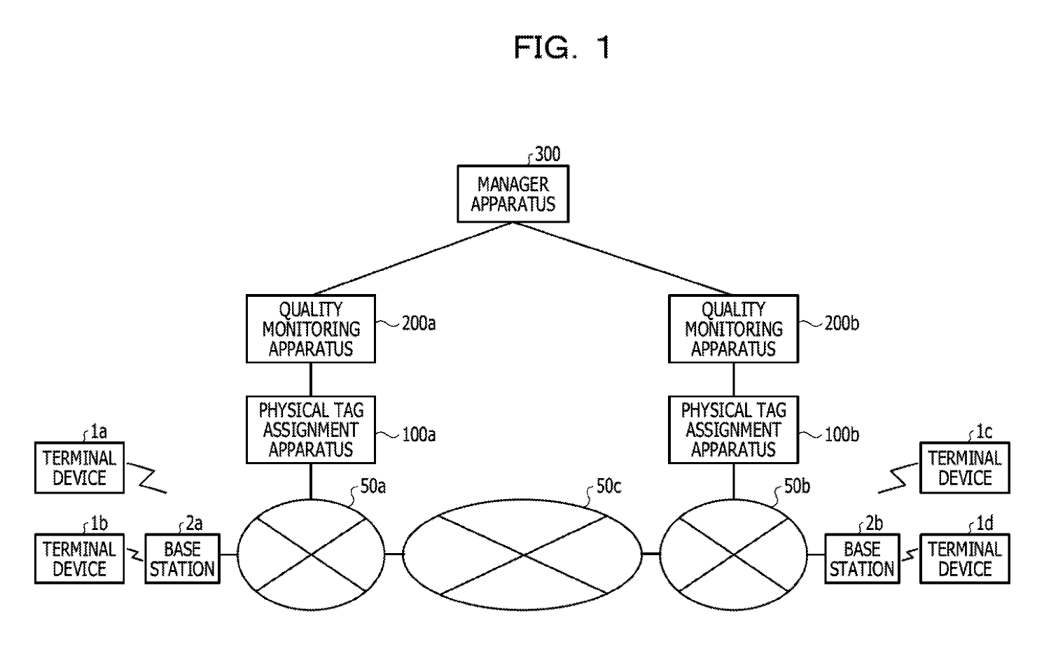

Next, we proceed to description of the present embodiments. FIG. 1 is a diagram illustrating the configuration of a system according to a first embodiment. As illustrated in FIG. 1, the system includes terminal devices 1a to 1d, base stations 2a and 2b, physical tag assignment apparatuses 100a, 100b, quality monitoring apparatuses 200a, 200b, and a manager apparatus 300. The physical tag assignment apparatuses 100a, 100b each represent an identification information assignment apparatus. The quality monitoring apparatuses 200a, 200b each represent a packet processing unit.

The terminal devices 1a to 1d are terminal devices used by users, each of which represents a mobile phone, a smartphone, a notebook personal computer (PC). In the following description, the terminal devices 1a to 1d are collectively denoted by the terminal device 1 as needed. Although the terminal devices 1a to 1d are illustrated here, the system according to the first embodiment may have other terminal devices.

The base stations 2a, 2b are apparatuses that relay communication between the terminal device 1 and a network. For instance, the base station 2a relays communication between the terminal devices 1a, 1b and a network 50a. The base station 2b relays communication between the terminal devices 1c, 1d and a network 50b. Although the base stations 2a, 2b are illustrated here, the system according to the first embodiment may have other base stations.

The networks 50a, 50b are networks that have a monitoring node, TAP and others. The network 50c is a network that represents an internet protocol (IP) router network or the like.

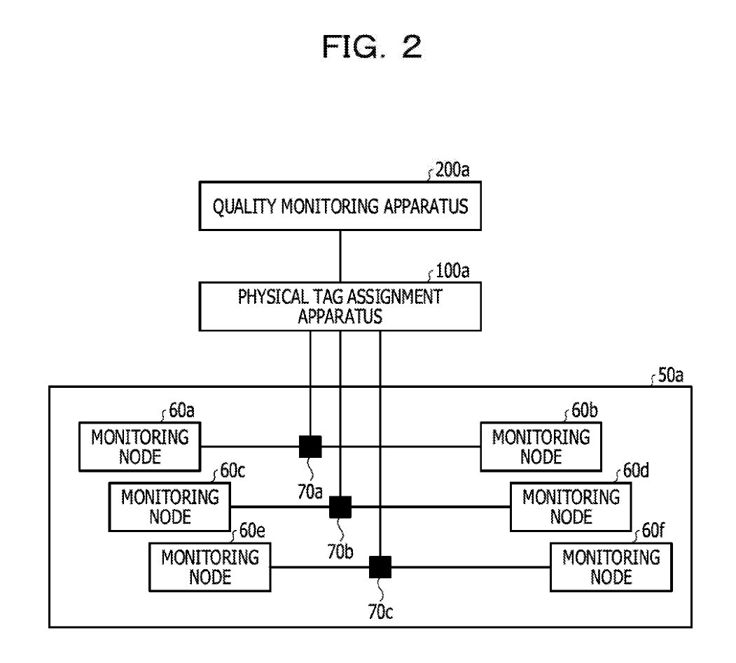

As an example, the network 50a will be described. FIG. 2 is a diagram illustrating an example network. Description of the network 50b is omitted because it is the same as the description of the network 50a.

As illustrated in FIG. 2, the network 50a includes monitoring nodes 60a to 60f, and TAPs 70a to 70c. When a session is established between terminal devices 1, the monitoring nodes 60a to 60f relay C-Plane packets and U-Plane packets transmitted and received between the session establishment and the session termination by the same set of monitoring nodes. In the following description, the monitoring nodes 60a to 60f, and the monitoring nodes included in the network 50b are collectively denoted by the monitoring node 60 as needed.

For instance, when a session is established between the terminal device 1a and the terminal device 1c, the monitoring nodes 60a, 60b relay C-Plane packets and U-Plane packets transmitted and received between the terminal device 1a and the terminal device 1c during the time between the session establishment and the session termination. When a session is established between the terminal device 1b and the terminal device 1d, the monitoring nodes 60c, 60d relay C-Plane packets and U-Plane packets transmitted and received between the terminal device 1b and the terminal device 1d during the time between the session establishment and the session termination. When a session is established between a terminal device 1 and a terminal device 1, the monitoring nodes 60e, 60f relay C-Plane packets and U-Plane packets transmitted and received between the terminal devices 1 during the time between the session establishment and the session termination.

The TAPs 70a to 70c are branching units, and perform mirroring on a packet that flows through the network 50a. The TAPs 70a to 70c then output the packet, which has undergone mirroring, to the physical tag assignment apparatus 100a. For instance, the TAP 70a performs mirroring on a packet which is transmitted and received between the monitoring node 60a and the monitoring node 60b. The TAP 70a then outputs the packet, which has undergone mirroring, to the physical tag assignment apparatus 100a. In other words, the TAP 70a duplicates a packet which flows from the monitoring node 60a to the monitoring node 60b. The TAP 70a then outputs the duplicated packet to the physical tag assignment apparatus 100a. The TAP 70a duplicates a packet which flows from the monitoring node 60b to the monitoring node 60a. The TAP 70a then outputs the duplicated packet to the physical tag assignment apparatus 100a. The TAP 70b performs mirroring on a packet which is transmitted and received between the monitoring node 60c and the monitoring node 60d. The TAP 70b then outputs the packet, which has undergone mirroring, to the physical tag assignment apparatus 100a. The TAP 70c performs mirroring on a packet which is transmitted and received between the monitoring node 60e and the monitoring node 60f. The TAP 70c then outputs the packet, which has undergone mirroring, to the physical tag assignment apparatus 100a. In the following description, the TAPs 70a to 70c, the TAPs included in the network 50b are collectively denoted by the TAP 70 as needed.

Returning to description of FIG. 1, the physical tag assignment apparatuses 100a, 100b are apparatuses that, when receiving a packet from the TAP 70, assign a physical tag as packet identification information to the packet. The physical tag assignment apparatus 100a outputs the packet with an assigned physical tag to the quality monitoring apparatus 200a. The physical tag assignment apparatus 100b outputs the packet with an assigned physical tag to the quality monitoring apparatus 200b. In the following description, the physical tag assignment apparatuses 100a, 100b are collectively denoted by the physical tag assignment apparatus 100 as needed.

The physical tag assignment apparatus 100 has a NIC card. The physical tag assignment apparatus 100 receives a packet branched from the TAP 70 via a NIC interface of the NIC card. The physical tag assignment apparatus 100 assigns an identifier to the packet as a physical tag, the identifier uniquely identifying the NIC interface of the NIC card via which the packet is received. As an example, the NIC interface is a physical port of the NIC card, and for instance, is a physical port corresponding to each of the TAP 70a, TAP 70b, TAP 70c in FIG. 2. The physical tag assignment apparatus 100 then assigns the identifier uniquely identifying the NIC interface of the NIC card to the received packet.

The quality monitoring apparatuses 200a, 200b are apparatuses that generate statistical information based on packets obtained from the respective physical tag assignment apparatuses 100a, 100b. The quality monitoring apparatuses 200a, 200b have multiple cores, and distribute packets to the cores and cause the cores to execute processing. The quality monitoring apparatuses 200a, 200b transmit the generated statistical information to the manager apparatus 300. In the following description, the quality monitoring apparatuses 200a, 200b are collectively denoted by the quality monitoring apparatus 200 as needed.

The quality monitoring apparatus 200 refers to a load configuration file that associates the identification information of a core that processes a packet with the identifier of a physical tag. The quality monitoring apparatus 200 then determines a core which is a distribution destination of a packet based on the load configuration file and the physical tag of the packet. This embodiment describes the case where the load configuration file is provided. However, instead of providing a load configuration file, it is also possible to calculate a physical tag value by a hash function and to automatically distribute a packet to a core based on the calculation result.

The manager apparatus 300 is an apparatus that receives statistical information from the quality monitoring apparatus 200 and detects a deterioration of a network based on the received statistical information. The manager apparatus 300, when detecting a deterioration of a network based on the statistical information, transmits an alarm indicating the detail and occurrence location of the deterioration to an alarm management system which is not illustrated.

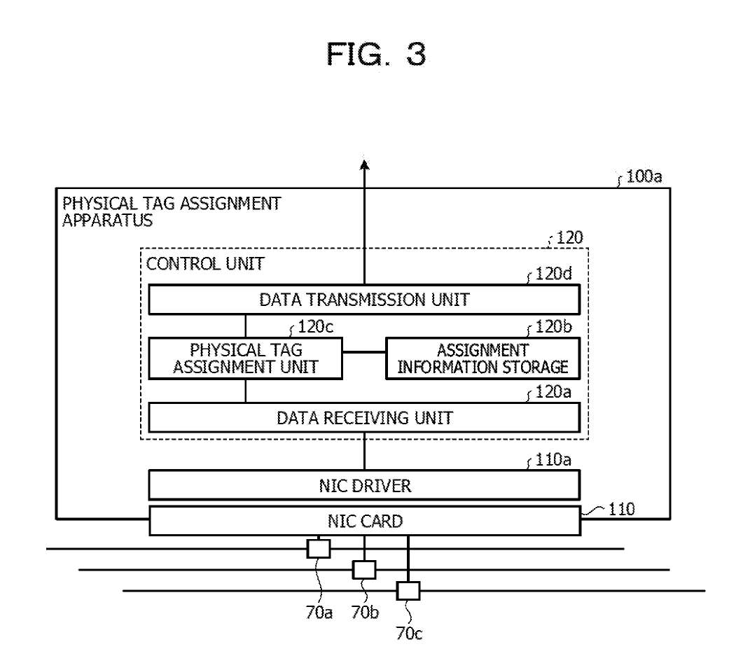

Next, an example configuration of the physical tag assignment apparatus 100a illustrated in FIG. 1 will be described. The configuration of the physical tag assignment apparatus 100b is the same as the configuration of the physical tag assignment apparatus 100a, and thus a description is omitted. FIG. 3 is a functional block diagram illustrating the configuration of a physical tag assignment apparatus according to the first embodiment. As illustrated in FIG. 3, the physical tag assignment apparatus 100a has a NIC card 110, a NIC driver 110a, and a control unit 120.

The NIC card 110 is an apparatus that receives a packet from the TAP 70. For instance, the NIC card 110 is coupled to the TAP 70a via a NIC interface eth2 (physical port eth2). The NIC card 110 is coupled to the TAP 70b via a NIC interface eth3. The NIC card 110 is coupled to the TAP 70c via a NIC interface eth4.

The NIC driver 110a is a processing unit that controls the NIC card 110. The NIC driver 110a outputs a packet received from the TAP 70 to the control unit 120.

The control unit 120 includes a data receiving unit 120a, an assignment information storage 120b, a physical tag assignment unit 120c, and a data transmission unit 120d. The control unit 120 represents an integrated apparatus such as an application specific integrated circuit (ASIC) or a field programmable gate array (FPGA). The control unit 120 represents, for instance, an electronic circuit such as a central processing unit (CPU) or a micro processing unit (MPU).

The data receiving unit 120a is a processing unit that obtains a packet from the NIC driver 110a. Each time the data receiving unit 120a receives a packet, the data receiving unit 120a outputs the packet to the physical tag assignment unit 120c.

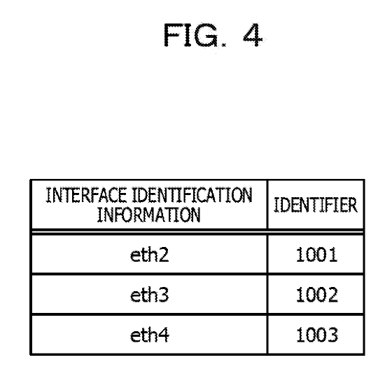

The assignment information storage 120b is a storage that holds assignment information. The assignment information is information that defines an identifier which is assigned to a packet as a physical tag. FIG. 4 is a table illustrating an example data structure of the assignment information. As illustrated in FIG. 4, the assignment information associates interface identification information with an identifier. The interface identification information is information that uniquely identifies a NIC interface. The identifier is an identifier that is assigned to a packet as a physical tag.

For instance, an identifier “1001” is assigned to a packet which is received from the NIC interface which is identified by the interface identification information “eth2”. An identifier “1002” is assigned to a packet which is received from the NIC interface which is identified by the interface identification information “eth2”. An identifier “1003” is assigned to a packet which is received from the NIC interface which is identified by the interface identification information “eth3”. That is, a packet transmitted and received between the monitoring node 60a and the monitoring node 60b in FIG. 2 is received by the TAP 70a via the NIC card 110. The packet is received at the corresponding interface (physical port) with the identification information eth2 of the NIC card 110. An identifier is then assigned to a packet transmitted and received between the monitoring node 60a and the monitoring node 60b.

The physical tag assignment unit 120c is a processing unit that assigns a physical tag to a packet based on the information on the NIC interface which has received the packet and the assignment information stored in the assignment information storage 120b. The physical tag assignment unit 120c represents an identification information assignment unit.

Here, the physical tag assignment unit 120c may obtain information on the NIC interface which has received the packet, in any manner. For instance, for each packet, the physical tag assignment unit 120c may obtain the information, from the NIC driver 110a, on the NIC interface which has received the packet. Alternatively, from an operating system (OS) which manages each processing unit of the physical tag assignment apparatus 100a, the physical tag assignment unit 120c may obtain the information on the NIC interface which has received the packet.

The physical tag assignment unit 120c, when obtaining a packet from the data receiving unit 120a, compares the assignment information with the information on the NIC interface which has received the packet, and determines an identifier to be assigned to the packet. The physical tag assignment unit 120c assigns the determined identifier to the packet as a physical tag. The physical tag assignment unit 120c outputs the packet with an assigned physical tag to the data transmission unit 120d. Each time obtaining a packet, the physical tag assignment unit 120c repeats the processing described above.

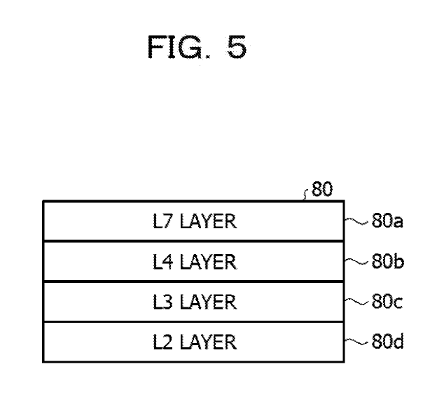

Here, the data structure of a packet before a physical tag is assigned, and the data structure of a packet after a physical tag is assigned will be described. FIG. 5 is a diagram illustrating an example data structure of a packet before a physical tag is assigned. As illustrated in FIG. 5, a packet 80 includes L7 layer 80a, L4 layer 80b, L3 layer 80c, and L2 layer 80d.

The L7 layer 80a stores information regarding a session initiation protocol (SIP) or a real-time transport protocol (RTP). The L4 layer 80b stores information regarding a user datagram protocol (UDP) or a transmission control protocol (TCP).

The L3 layer 80c stores information regarding an internet protocol version 4 (IPv4) header or an internet protocol version 6 (IPv6) header. The L2 layer 80d stores information regarding Ether header.

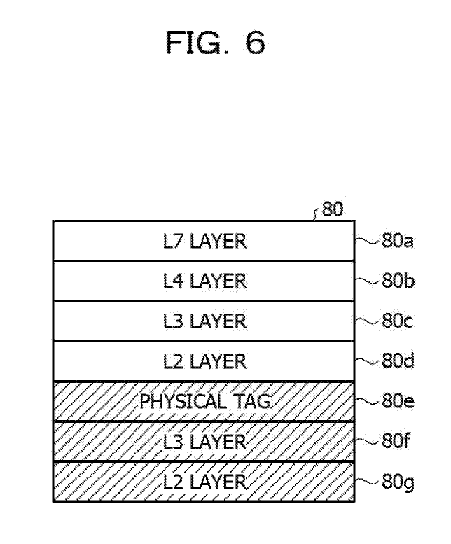

FIG. 6 is a diagram illustrating an example data structure of a packet after a physical tag is assigned. As illustrated in FIG. 6, L7 the packet 80 includes L7 layer 80a, L4 layer 80b, L3 layer 80c, L2 layer 80d, physical tag 80e, L3 layer 80f, L2 layer 80g. Among these, description of L7 layer 80a, L4 layer 80b, L3 layer 80c, L2 layer 80d is the same as the description given with reference to FIG. 5.

As described above, the physical tag 80e stores information on an identifier which is determined by the physical tag assignment unit 120c. The L3 layer 80f stores information regarding IPv4 header or IPv6 header. The L2 layer 80g stores information regarding Ether header.

Here, L3 layer 80c and L2 layer 80d originally included in the packet 80 includes information which is utilized when data communication is performed between terminal devices 1. On the other hand, L3 layer 80c and L2 layer 80d include information which is utilized when data communication is performed between the physical tag assignment apparatus 100 and the quality monitoring apparatus 200. The information on L3 layer 80c and L2 layer 80d of the packet 80 may be assigned by the physical tag assignment apparatus 120c or the data transmission unit 120d described later.

The data transmission unit 120d is a processing unit that, when obtaining a packet with an assigned physical tag from the physical tag assignment unit 120c, transmits the obtained packet to the quality monitoring apparatus 200. The data transmission unit 120d is an example of a transmission unit.

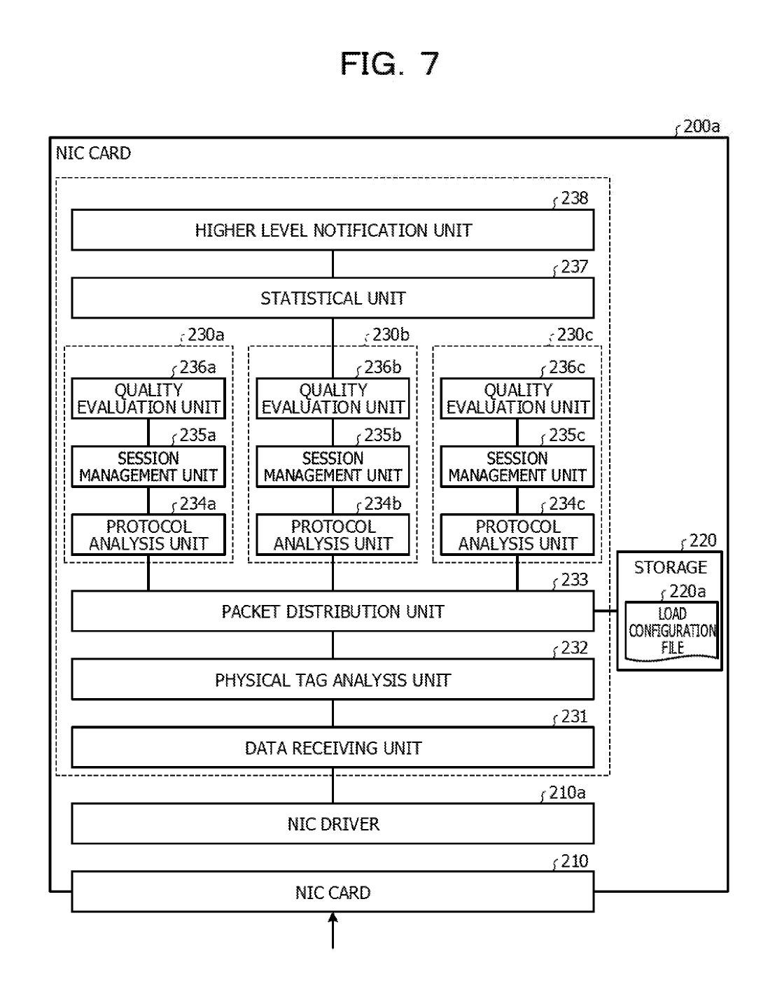

Next, an example configuration of the quality monitoring apparatus 200a illustrated in FIG. 1 will be described. The configuration of the quality monitoring apparatus 200b is the same as the configuration of the quality monitoring apparatus 200a, and thus a description is omitted. FIG. 7 is a functional block diagram illustrating the configuration of the quality monitoring apparatus according to the first embodiment. As illustrated in FIG. 7, the quality monitoring apparatus 200a includes a NIC card 210, a NIC driver 210a, a storage 220, a data receiving unit 231, a physical tag analysis unit 232, and a packet distribution unit 233. The quality monitoring apparatus 200a includes protocol analysis units 234a to 234c, session management units 235a to 235c, and quality evaluation units 236a to 236c.

For instance, the protocol analysis unit 234a, the session management unit 235a, and the quality evaluation unit 236a are processed by the core 230a. The protocol analysis unit 234b, the session management unit 235b, and the quality evaluation unit 236b are processed by the core 230b. The protocol analysis unit 234c, the session management unit 235c, and the quality evaluation unit 236c are processed by the core 230c. The cores 230a to 230c each represent an integrated apparatus such as an ASIC or an FPGA. The cores 230a to 230c each represent, for instance, an electronic circuit such as a CPU or an MPU.

The NIC card 210 is an apparatus that receives a packet which is assigned a physical tag from the physical tag assignment apparatus 100a. In following description regarding the quality monitoring apparatuses 200a, a packet, which is assigned a physical tag from the physical tag assignment apparatus 100a, is simply referred to as a packet.

The NIC driver 210a is a processing unit that controls the NIC card 210. The NIC driver 210a outputs a packet received from the physical tag assignment apparatus 100a to the data receiving unit 231.

The storage 220 includes a load configuration file 220a. The storage 220 represents a semiconductor memory element such as a random access memory (RAM), a read only memory (ROM), a flash memory or a storage apparatus such as a hard disk drive (HDD).

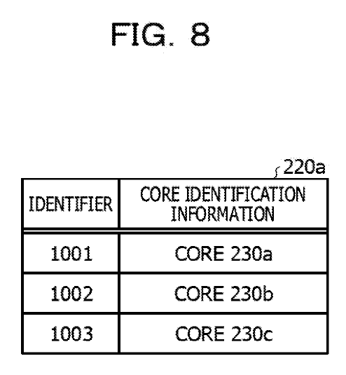

The load configuration file 220a is information that defines a core which is a distribution destination of a packet. FIG. 8 is a table illustrating an example data structure of the load configuration file according to the first embodiment. As illustrated in FIG. 8, the load configuration file 220a associates each identifier with core identification information. The identifier is included in the physical tag of a packet. The core identification information is information that uniquely identifies the cores 230a to 230c. This embodiment describes the case where the load configuration file is provided. However, instead of providing a load configuration file, it is also possible to calculate a physical tag value by a hash function and to automatically distribute a packet to a core based on the calculation result.

In FIG. 8, when the identifier assigned to a packet is “1001”, the packet is distributed to the “core 230a”. When the identifier assigned to a packet is “1002”, the packet is distributed to the “core 230b”. When the identifier assigned to a packet is “1003”, the packet is distributed to the “core 230c”.

The data receiving unit 231 is a processing unit that obtains a packet from the NIC driver 210a. The data receiving unit 231 outputs the obtained packet to the physical tag analysis unit 232.

The physical tag analysis unit 232 is a processing unit that refers to a physical tag inserted in the header of a packet, and determines an identifier set to the physical tag. The physical tag analysis unit 232 outputs the packet and the identifier to the packet distribution unit 233.

The packet distribution unit 233 is a processing unit that compares an identifier corresponding to a packet with the load configuration file 220a, and determines a core which is a distribution destination of the packet. The packet distribution unit 233 outputs the packet to the determined core. The packet distribution unit 233 is an example distribution unit.

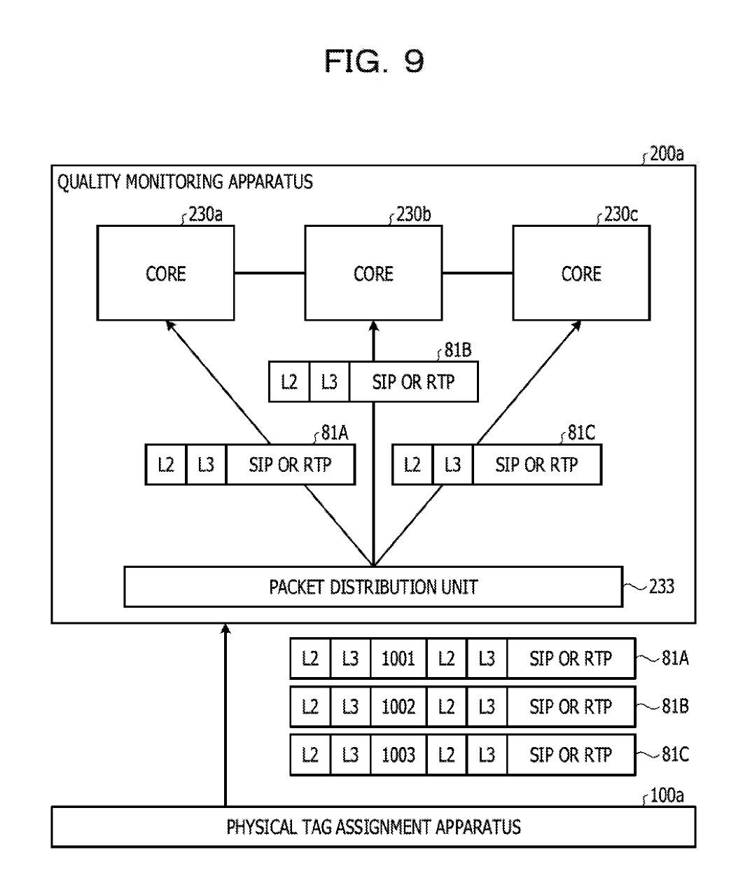

FIG. 9 is a diagram for illustrating the processing of a packet distribution unit according to the first embodiment. In the example illustrated in FIG. 9, the quality monitoring apparatus 200a receives packets 81A, 81B, 81C from the physical tag assignment apparatus 100a. The identifier set to the physical tag of the packet 81A is assumed to be “1001”. The identifier set to the physical tag of the packet 81B is assumed to be “1002”. The identifier set to the physical tag of the packet 81C is assumed to be “1003”. The data structure of the packets 81A to 81C is the same as the data structure described with reference to FIG. 6, and thus a description is omitted.

The packet distribution unit 233 compares the load configuration file 220a illustrated in FIG. 8 with the identifier of a packet, and determines a distribution destination of the packet. Specifically, the packet distribution unit 233 outputs the packet 81A to the core 230a. The packet distribution unit 233 outputs the packet 81B to the core 230b. The packet distribution unit 233 outputs the packet 81C to the core 230c.

Returning to description of FIG. 7, the protocol analysis units 234a to 234c are processing units that refer to the information in the header/payload of the packet distributed by the packet distribution unit 233, and extract information which is used for determining session management and statistical information. The protocol analysis units 234a to 234c output the information extracted from a packet to the session management units 235a to 235c.

The session management units 235a to 235c are processing units that perform resource management for state management of each session and holding statistical information, based on the information extracted from a packet by the protocol analysis units 234a to 234c. The session management units 235a to 235c output the information obtained from the protocol analysis units 234a to 234c to the quality evaluation units 236a to 236c.

The quality evaluation units 236a to 236c are processing units that calculate statistical information per session managed by the session management units 235a to 235c, based on the information extracted from a packet by the protocol analysis units 234a to 234c. The quality evaluation units 236a to 236c output the statistical information to a statistical unit 237.

The statistical unit 237 is a processing unit that obtains statistical information from the quality evaluation units 236a to 236c. The statistical unit 237 summarizes the statistical information in a certain cycle, and outputs the summarized statistical information to a higher level notification unit 238.

The higher level notification unit 238 is a processing unit that transmits statistical information to the manager apparatus 300.

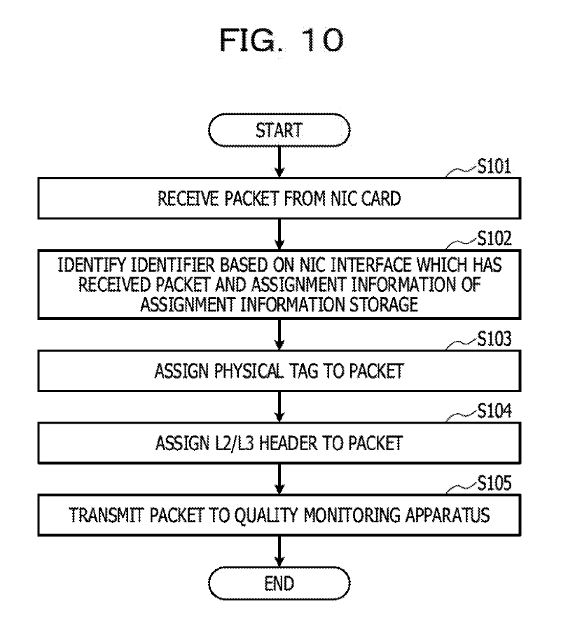

Next, the processing steps performed by the physical tag assignment apparatus 100a will be described. The processing steps performed by the physical tag assignment apparatus 100b are the same as the processing steps performed by the physical tag assignment apparatus 100a, and thus a description is omitted. FIG. 10 is a flowchart illustrating the processing steps performed by the physical tag assignment apparatus according to the first embodiment. As illustrated in FIG. 10, the data receiving unit 120a of the physical tag assignment apparatus 100a receives a packet from the NIC card 110 (S101).

The data receiving unit 120a of the physical tag assignment apparatus 100a identifies and determines an identifier based on the identification information of the NIC interface which has received a packet, and the assignment information of the assignment information storage 120b (S102). The data receiving unit 120a of the physical tag assignment apparatus 100a assigns the physical tag included in the determined identifier to the packet (S103).

The data transmission unit 120d of the physical tag assignment apparatus 100a assigns L2/L3 header to the packet (S104). The data transmission unit 120d of the physical tag assignment apparatus 100a transmits the packet to the quality monitoring apparatus 200a (S105).

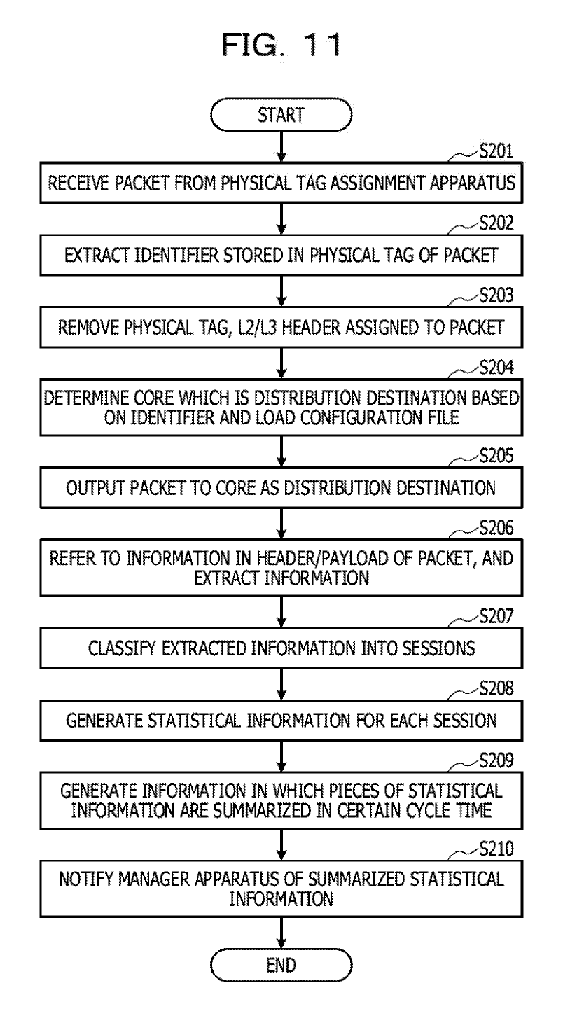

Next, the processing steps performed by the quality monitoring apparatus 200a will be described. The processing steps performed by the quality monitoring apparatus 200b are the same as the processing steps performed by the quality monitoring apparatus 200a. FIG. 11 is a flowchart illustrating the processing steps performed by the quality monitoring apparatus according to the first embodiment. The NIC card 210 of the quality monitoring apparatus 200a receives a packet from the physical tag assignment apparatus 100 (S201).

The physical tag analysis unit 232 of the quality monitoring apparatus 200a extracts an identifier stored in the physical tag of the packet (S202). The physical tag analysis unit 232 removes the physical tag and the L2/L3 header assigned to the packet (S203).

The packet distribution unit 233 of the quality monitoring apparatus 200a determines a core which is a distribution destination based on the identifier and the load configuration file 220a (S204). The packet distribution unit 233 outputs the packet to the core as the distribution destination (S205). In the following description of S206 to S208, the case will be described where the packet distribution unit 233 outputs a packet to the core 230a. The processing performed when the cores 230b, 230c obtain a packet is the same as the processing performed when the cores 230a obtains a packet.

The protocol analysis unit 234a of the core 230a refers to the information in the header/payload of the packet. The protocol analysis unit 234a then extracts information which is used for determining session management and statistical information (S206). The session management unit 235a of the core 230a classifies the information extracted by the protocol analysis unit 234a into sessions (S207).

The quality evaluation unit 236a of the core 230a generates statistical information for each session (S208). The statistical unit 237 of the quality monitoring apparatus 200a generates information in which the pieces of statistical information are summarized in a certain cycle time (S209). The higher level notification unit 238 of the quality monitoring apparatus 200a transmits the summarized statistical information to the manager apparatus 300 (S210).

Next, the effect of the system according to the first embodiment will be described. The physical tag assignment apparatus 100 according to the first embodiment assigns a physical tag to a packet based on the NIC interface of the NIC card which has received a packet. The physical tag assignment apparatus 100 then transmits the packet with an assigned physical tag to the quality monitoring apparatus 200. The quality monitoring apparatus 200 determines a core which executes the processing of the packet, based on the physical tag assigned to the packet. The quality monitoring apparatus 200 outputs a packet to the determined core and causes the core to execute processing. Thus, it is possible to simply and efficiently perform load distribution of predetermined processing for each packet.

For instance, C-Plane packets and U-Plane packets transmitted and received between the same terminal devices 1 during the time between session establishment and session termination have a feature to pass through the links of the same set of monitoring nodes. This corresponds to a situation that, for instance, the C-Plane packets and U-Plane packets transmitted and received between the terminal device 1a and the terminal device 1c in FIG. 1, are transmitted and received between the monitoring node 60a and the monitoring node 60b in FIG. 2.

A packet between the monitoring nodes is inputted by the TAP 70 to a predetermined NIC interface of the NIC card of the physical tag assignment apparatus 100. This corresponds to a situation that, for instance, the packets transmitted and received between the monitoring node 60a and the monitoring node 60b in FIG. 2, are received by the TAP 70a via, for instance, the interface (physical port) of the interface identification information eth2 illustrated in FIG. 4 of the NIC card of the physical tag assignment apparatus 100.

Thus, as described above, assignment to a packet of a physical tag according to the identification information of the NIC interface allows the same physical tag to be assigned to the C-Plane packets and U-Plane packets which are transmitted and received between the same terminal devices 1 during the time between session establishment and session termination.

As described above, the quality monitoring apparatus 200 assigns a packet to a core based on the physical tag, thereby making it possible to assign related C-Plane packets and U-Plane packets to the same core. Since related C-Plane packets and U-Plane packets are processable by the core itself, it is possible to calculate statistical information without any cooperation with other cores. In other words, for instance, when a shared memory is used to cooperate with other cores, waiting for a process associated with exclusive control is avoidable.

Since the quality monitoring apparatus 200 determines a distribution destination of a packet by referring to a physical tag, related packets may be assigned to the same core without associating a C-Plane packet with a U-Plane packet by conducting analysis to the L7 layer.

### Second Embodiment

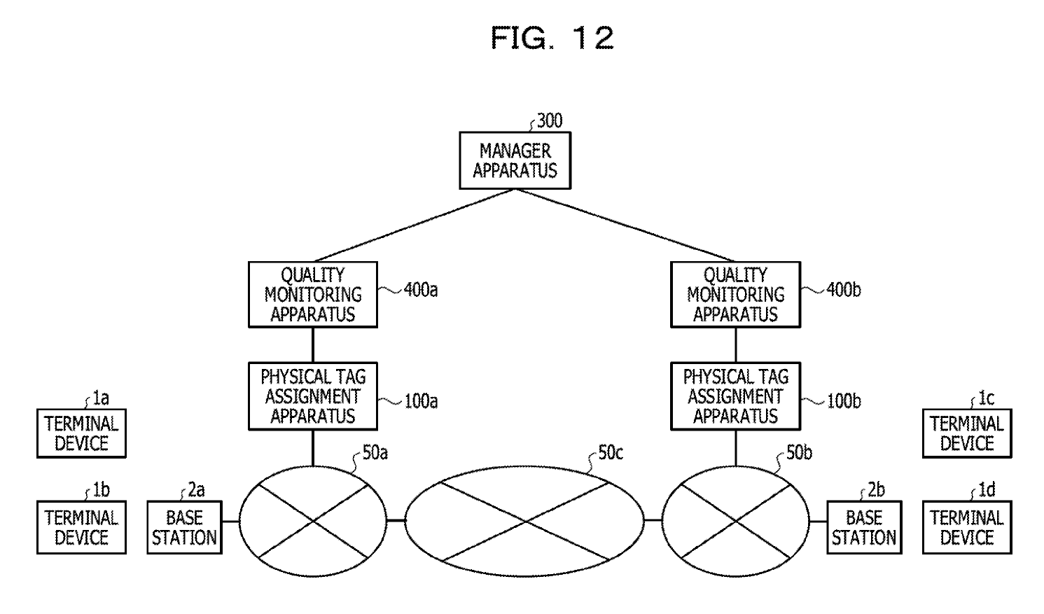

Next, the configuration of a system according to a second embodiment will be described. FIG. 12 is a diagram illustrating the configuration of a system according to the second embodiment. As illustrated in FIG. 12, the system includes the terminal devices 1a to 1d, the base stations 2a and 2b, the physical tag assignment apparatuses 100a, 100b, the manager apparatus 300, and quality monitoring apparatuses 400a, 400b. The quality monitoring apparatuses 400a, 400b each represent a packet processing unit.

Among these, description of the terminal devices 1a to 1d, the base stations 2a and 2b, the physical tag assignment apparatuses 100a, 100b, and the manager apparatus 300 is the same as the description in the first embodiment. Thus, the same symbol is labeled and a description is omitted.

The quality monitoring apparatuses 400a, 400b are apparatuses that generate statistical information based on packets obtained from the respective physical tag assignment apparatuses 100a, 100b. The quality monitoring apparatuses 400a, 400b have multiple cores, and distribute packets to the cores and cause the cores to execute processing. The quality monitoring apparatuses 400a, 400b transmit the generated statistical information to the manager apparatus 300. In the following description, the quality monitoring apparatuses 400a, 400b are collectively denoted by the quality monitoring apparatus 400 as needed.

The quality monitoring apparatus 400 refers to a load configuration file that associates the identification information of a core that processes a packet with the identifier of a physical tag. The quality monitoring apparatus 400 then determines a core which is a distribution destination of a packet based on the load configuration file and the physical tag of the packet. The relationship between a core and an identifier of a load configuration file according to the second embodiment is set so that substantially the same amount of packets are distributed to each core based on busy hour call attempts (BHCA) between monitoring nodes.

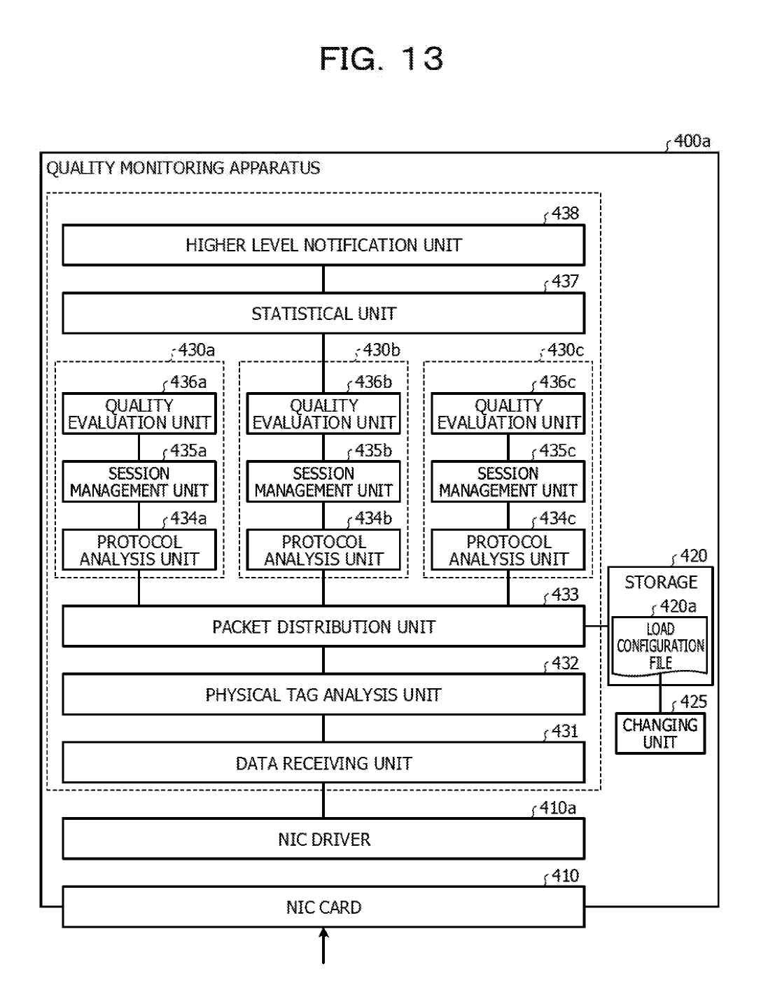

Next, an example configuration of the quality monitoring apparatus 400a illustrated in FIG. 13 will be described. The configuration of the quality monitoring apparatus 400b is the same as the configuration of the quality monitoring apparatus 400a, and thus a description is omitted. FIG. 13 is a functional block diagram illustrating the configuration of a quality monitoring apparatus according to the second embodiment. As illustrated in FIG. 13, the quality monitoring apparatus 200a includes a NIC card 410, a NIC driver 410a, a storage 420, a changing unit 425, a data receiving unit 431, a physical tag analysis unit 432, a packet distribution unit 433, protocol analysis units 434a to 434c, session management units 435a to 435c, and quality evaluation units 436a to 436c.

For instance, the protocol analysis unit 434a, the session management unit 435a, and the quality evaluation unit 436a are processed by the core 430a. The protocol analysis unit 434b, the session management unit 435b, and the quality evaluation unit 436b are processed by the core 430b. The protocol analysis unit 434c, the session management unit 435c, and the quality evaluation unit 436c are processed by the core 430c. The cores 430a to 430c each represent an integrated apparatus such as an ASIC or an FPGA. The cores 430a to 430c each represent, for instance, an electronic circuit such as a CPU or an MPU.

Description of the NIC card 410, the NIC driver 410a, the data receiving unit 431, and the physical tag analysis unit 432 is the same as the description of the NIC card 210, the NIC driver 210a, the data receiving unit 231, and the physical tag analysis unit 232 given with reference to FIG. 7. Description of the protocol analysis units 434a to 434c, the session management units 435a to 435c, and the quality evaluation units 436a to 436c is the same as the description of the protocol analysis units 234a to 234c, the session management units 235a to 235c, and the quality evaluation units 236a to 236c given with reference to FIG. 7. Description of the statistical unit 437 and the higher level notification unit 438 is the same as the description of the statistical unit 237 and the higher level notification unit 238 given with reference to FIG. 7.

The storage unit 420 has a load configuration file 420a. The storage 420 represents a semiconductor memory element such as a RAM, a ROM, a flash memory or a storage apparatus such as a HDD.

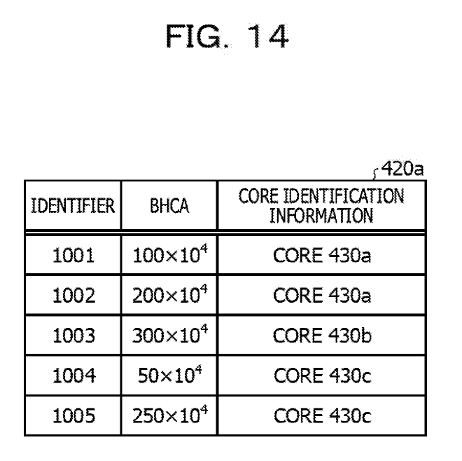

The load configuration file 420a is information that defines a core which is a distribution destination of a packet. FIG. 14 is a table illustrating an example data structure of a load configuration file according to the second embodiment. As illustrated in FIG. 14, the load configuration file 420a associates identifier, BHCA, with core identification information.

The identifier is included in the physical tag of a packet. The BHCA indicates the total number of calls for a line between the monitoring nodes coupled to a NIC interface corresponding to an identifier via the TAP 70. The core identification information is information that uniquely identifies the cores 430a to 430c.

The load configuration file 420a is set so that the total values of BHCA corresponding to the pieces of core identification information are uniform. For instance, in FIG. 14, the BHCA corresponding to the core identification information 430a is BHCA “100×10⁴”, “200×10⁴” on the first and second rows. Thus, the total value of BHCA is “300×10⁴”. The BHCA corresponding to the core identification information 430b is “300×10⁴” on the third row, which is the total value of BHCA is “300×10⁴”. The BHCA corresponding to the core identification information 430c is BHCA “50×10⁴”, “250×10⁴” on the fourth and fifth rows. Thus, the total value of BHCA is “300×10⁴”.

For instance, the BHCA of the identifier “1001” is the BHCA between the monitoring apparatuses 60a, 60b illustrated in FIG. 2. The BHCA of the identifier “1002” is the BHCA between the monitoring apparatuses 60c, 60d illustrated in FIG. 2. The BHCA of the identifier “1003” is the BHCA between the monitoring apparatuses 60e, 60f illustrated in FIG. 2. The BHCA of the identifier “1004” is the BHCA between the monitoring apparatuses 60g, 60h which are not illustrated. The BHCA of the identifier “1005” is the BHCA between the monitoring apparatuses 60i, 60j which are not illustrated.

The changing unit 425 is a processing unit that changes the correspondence relationship between identifier and core identification information of the load configuration file 420a based on the BHCA corresponding to the identifier. The changing unit 425 changes the correspondence relationship between identifier and core identification information so that the total values of BHCA corresponding to the pieces of core identification information are uniform.

For instance, the changing unit 425 selects an identifier corresponding to each of the 1st to nth greatest BHCAs. The changing unit 425 then associates the selected identifier with each core identification information, where n is a natural number indicating the number of types of core. When the number of cores is three, n is 3. After the above-mentioned correspondence is established, the changing unit 425 determines a correspondence for which the total value of BHCA corresponding to each core has a minimum. The changing unit 425 establishes a correspondence between the remaining identifiers and core identification information based on a result of the determination.

The changing unit 425 may perform the above-described processing in a certain cycle or may perform the processing when directions are given by an administrator or the like.

The changing unit 425 may obtain the information on BHCA from an external apparatus that monitors the BHCA between the monitoring nodes, and may update the value of BHCA of a corresponding identifier of the load configuration file 420a based on the obtained information.

The packet distribution unit 433 is a processing unit that compares the load configuration file 420a illustrated in FIG. 14 with an identifier assigned to a packet, and determines a core which is a distribution destination of the packet. The packet distribution unit 433 outputs the packet to the determined core. The packet distribution unit 433 represents a distribution unit.

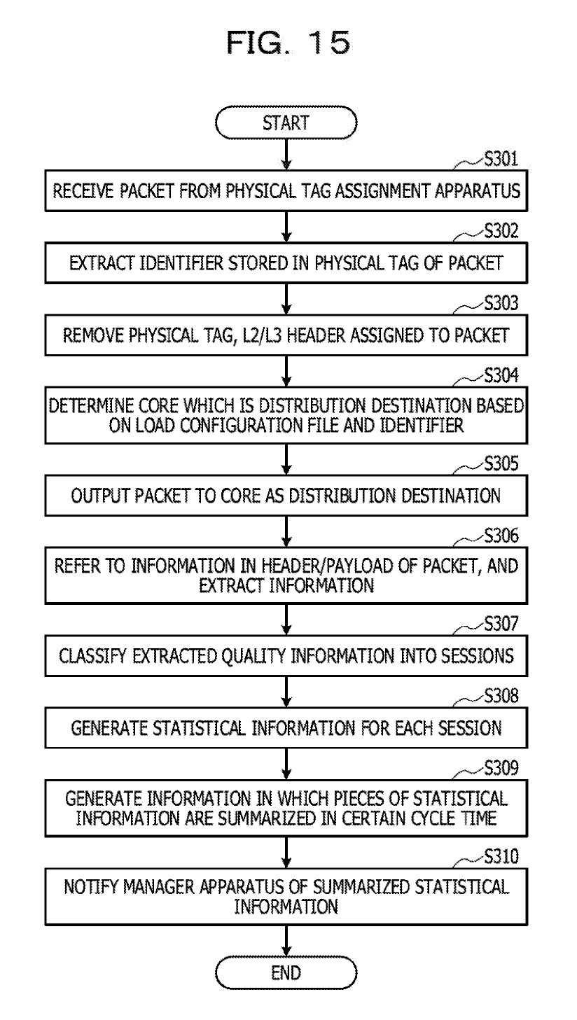

Next, the processing steps performed by the quality monitoring apparatus 400a will be described. The processing steps performed by the quality monitoring apparatus 400b are the same as the processing steps performed by the quality monitoring apparatus 400a. FIG. 15 is a flowchart illustrating the processing steps performed by the quality monitoring apparatus according to the second embodiment. The NIC card 410 of the quality monitoring apparatus 400a receives a packet from the physical tag assignment apparatus 100a (S301).

The physical tag analysis unit 432 of the quality monitoring apparatus 400a extracts an identifier stored in the physical tag of the packet (S302). The physical tag analysis unit 432 removes the physical tag and the L2/L3 header assigned to the packet (S303).

The packet distribution unit 433 of the quality monitoring apparatus 400a determines a core which is a distribution destination based on the load configuration file 420a and the identifier (S304). The packet distribution unit 433 outputs the packet to the core as the distribution destination (S305). In the following description of S306 to S308, the case will be described where the packet distribution unit 433 outputs a packet to the core 430a. The processing performed when the cores 430b, 430c obtain a packet is the same as the processing performed when the cores 430a obtains a packet.

The protocol analysis unit 434a of the core 430a refers to the information in the header/payload of the packet. The protocol analysis unit 434a then extracts information which is used for determining session management and statistical information (S306). The session management unit 435a of the core 430a classifies the information extracted by the protocol analysis unit 434a into sessions (S307).

The quality evaluation unit 436a of the core 430a generates statistical information for each session (S308). The statistical unit 437 of the quality monitoring apparatus 400a generates information in which the pieces of statistical information are summarized in a certain cycle time (S309). The higher level notification unit 438 of the quality monitoring apparatus 400a transmits the summarized statistical information to the manager apparatus 300 (S310).

Next, the effect of the system according to the second embodiment will be described. In addition to the effect achieved by the first embodiment, the system according to the second embodiment achieves the following effect. That is, the quality monitoring apparatus 400 according to the second embodiment 2 determines a core which executes the processing of a packet based on the physical tag assigned to a packet the load configuration file 420a which is set so that the total values of BHCA corresponding to the pieces of core identification information are uniform. Therefore, it is possible to avoid concentration of packets on part of the cores.

The changing unit 425 of the quality monitoring apparatus 400 updates the BHCA of the load configuration file 420a, and changes the relationship between identifier and core identification information based on the updated result so that the total values of BHCA corresponding to the pieces of core identification information are uniform. Consequently, even when the BHCA between the monitoring nodes changes, the correspondence relationship between identifier and core identification information is dynamically changeable, thereby making it possible to avoid concentration of packets on part of the cores.

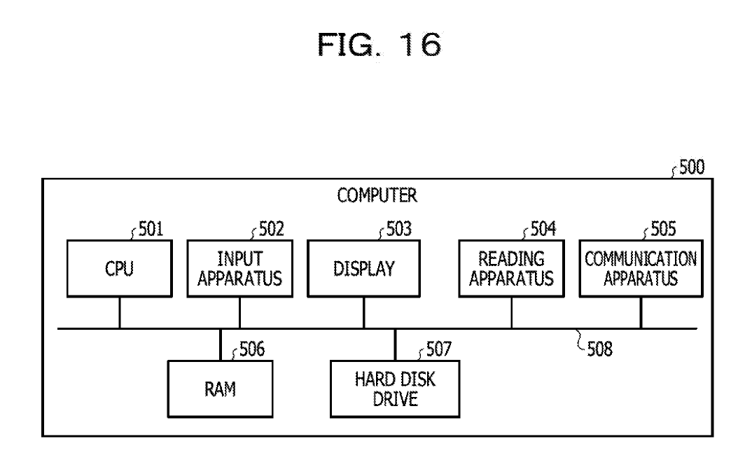

Next, an example hardware configuration of a computer that achieves the same function as that of the physical tag assignment apparatuses 100a, 100b illustrated in the first and second embodiments will be described. FIG. 16 is a diagram illustrating an example hardware configuration of a computer representing the physical tag assignment apparatus.

As illustrated in FIG. 16, a computer 500 includes a CPU 501 that executes various arithmetic processing, an input apparatus 502 that receives input of data from a user, and a display 503. The computer 500 includes a reading apparatus 504 that reads a program or the like from a storage medium, and a communication apparatus 505 that transmits and receives data to and from other computers via a network. For instance, the communication apparatus 505 represents the NIC card 110, and is coupled to the TAP 70. The computer 500 includes a RAM 506 that temporarily stores a variety of information and a hard disk drive 507. The apparatuses 501 to 507 are coupled to a bus 508.

For instance, the CPU 501 performs processing corresponding to the processing of the data receiving unit 120a, the physical tag assignment unit 120c, and the data transmission unit 120d illustrated in FIG. 3. The assignment information storage 120b corresponds to the RAM 506 or the hard disk drive 507, for instance. The CPU 501 reads assignment information from the RAM 506 or the hard disk drive 507, and determines the identifier of a physical tag assigned to a packet. The hard disk drive 507 stores programs that cause the CPU 501 to execute processing corresponding to the processing of the data receiving unit 120a, the physical tag assignment unit 120c, and the data transmission unit 120d.

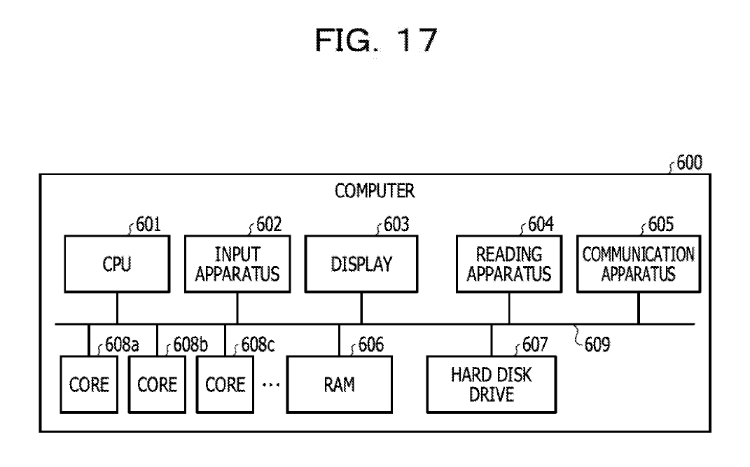

Next, an example hardware configuration of a computer that achieves the same function as that of the quality monitoring apparatuses 200a, 200b, 400a, 400b illustrated in the first and second embodiments will be described. FIG. 17 is a diagram illustrating an example hardware configuration of a computer representing the quality monitoring apparatus.

As illustrated in FIG. 17, a computer 600 includes a CPU 601 that executes various arithmetic processing, an input apparatus 602 that receives input of data from a user, and a display 603. The computer 600 includes a reading apparatus 604 that reads a program or the like from a storage medium, and a communication apparatus 605 that transmits and receives data to and from other computers via a network. For instance, the communication apparatus 605 represents the NIC cards 210 410. The computer 600 includes a RAM 606 that temporarily stores a variety of information and a hard disk drive 607. The computer 600 has cores 608a, 608b, 608c. Each core represents a CPU or the like. Although the cores 608a to 608c are illustrated here, the computer 600 may have other cores. The apparatuses 601 to 607 and the cores 608a to 608c are coupled to a bus 609.

For instance, the CPU 601 performs processing corresponding to the processing of the data receiving unit 231, the physical tag analysis unit 232, the packet distribution unit 233, the statistical unit 237, the higher level notification unit 238, and the changing unit 425 illustrated in FIG. 7. The core 608a performs processing corresponding to the processing of the protocol analysis unit 234a, the session management unit 235a, and the quality evaluation unit 236a illustrated in FIG. 7. The core 608b performs processing corresponding to the processing of the protocol analysis unit 234b, the session management unit 235b, and the quality evaluation unit 236b illustrated in FIG. 7. The core 608c performs processing corresponding to the processing of the protocol analysis unit 234c, the session management unit 235c, and the quality evaluation unit 236c illustrated in FIG. 7.

For instance, the RAM 606 or the hard disk drive 607 corresponds to the storage 220, and stores the load configuration file 220a. The CPU 601 reads the load configuration file 220a and compares it with the physical tag of a packet. The CPU 601 then determines a core which is a distribution destination of the packet. The CPU 601 controls the communication apparatus 605 to transmit the statistical information calculated by the cores 608a to 608c to the manager apparatus 300.

The hard disk drive 607 stores programs that cause the CPU 601 to execute processing corresponding to the processing of the data receiving unit 231, the physical tag analysis unit 232, the packet distribution unit 233, the statistical unit 237, the higher level notification unit 238, and the changing unit 425. The hard disk drive 607 stores programs that cause the cores 608a to 608c to execute processing corresponding to the processing of the protocol analysis units 234a to 234c, the session management units 235a to 235c, and the quality evaluation units 236a to 236c.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A packet processing method executed by a system including a first apparatus and a second apparatus, the first apparatus having a first processor and a plurality of interfaces and the second apparatus having a second processor and a plurality of third processors, the packet processing method comprising:
receiving, by the first processor, a packet via an interface in the plurality of interfaces;
storing identification information of the interface into the packet;
transmitting the packet to the second apparatus;
receiving, by the second processor, the packet transmitted from the first apparatus;
selecting a processor from the plurality of third processors based on the identification information included in the received packet; and
executing processing of the packet using the selected processor.

2. The packet processing method according to claim 1, wherein the executing includes:
generating, by the second processor, statistical information on quality of a network coupled to the interface, based on the received packet; and
transmitting the generated statistical information to a management apparatus coupled to the second apparatus.

3. The packet processing method according to claim 1, wherein the selecting includes
identifying, by the second processor, the identification information of the processor corresponding to the identification information of the interface, by referring to correspondence information in which identification information of an interface and identification information of a processor are associated with each other for each of the identification information of the plurality of interfaces.

4. The packet processing method according to claim 3, wherein
each of the plurality of interfaces is coupled to one of a plurality of links that couples between a plurality of nodes, and
the packet is a duplicated packet of a packet that is transmitted for communication between the plurality of nodes.

5. The packet processing method according to claim 4, further comprising
updating, by the second processor, the correspondence information to achieve uniform communication loads of the links.

6. The packet processing method according to claim 5,
wherein the communication loads are each a total number of calls for a line per unit time between the nodes.

7. The packet processing method according to claim 1,
wherein the selecting includes calculating a hash function using a value indicated by the identification information, and selecting a processor from the processors based on a result of the calculating.

8. A packet processing system, comprising:
a first apparatus that includes a first processor and a plurality of interfaces, the first processor configured to:
receive a packet via an interface in the interfaces,
store identification information of the interface into the packet, and
transmit the packet to the second apparatus; and
a second apparatus that includes a second processor and a plurality of third processors, the second processor configured to:
receive the packet transmitted from the first apparatus,
select a processor from the plurality of third processors based on the identification information included in the received packet, and
execute processing of the packet using the selected processor.

9. The packet processing system according to claim 8, wherein the second processor is configured to:
generate statistical information on quality of a network coupled to the interface, based on the packet, and
transmit the generated statistical information to a management apparatus coupled to the second apparatus.

10. The packet processing system according to claim 8, wherein the one of the plurality of second processors is configured to
identify the identification information of the processor corresponding to the identification information of the interface, by referring to correspondence information in which identification information of an interface and identification information of a processor are associated with each other for each of the identification information of the plurality of interfaces.

11. The packet processing system according to claim 10, wherein
each of the plurality of interfaces is coupled to one of a plurality of links that couples between a plurality of nodes, and
the packet is a duplicated packet of a packet that is transmitted for communication between the plurality of nodes.

12. The packet processing system according to claim 11, wherein the second processor is configured to
update the correspondence information to achieve uniform communication loads of the links.

13. The packet processing system according to claim 12,
wherein the communication loads are each a total number of calls for a line per unit time between the nodes.

14. The packet processing system according to claim 8, wherein the second processor is configured to
calculate a hash function using a value indicated by the identification information, and selecting a processor from the plurality of third processors based on a result of the calculating.
